(19) United States
(12) Patent Application Publication
(10) Pub. No.: US 2006/0015664 A1
(43) Pub. Date: Jan. 19, 2006

(54) Wireless Multimedia Device

(76) Inventor: Guobiao Zhang, Stateline, NV (US)

Correspondence Address: Dr.Guobiao Zhang, P.O. Box 6182, Stateline, NV, 89449-6182, US

(21) Appl. No.: 11/162,598

(22) Filed: Sep. 15, 2005

Related U.S. Application Data
(62) Division of application No. 11/162,596, filed on Sep. 15, 2005.
Application No. 11/162,596 is a continuation-in-part of application No. 10/908,383, filed on May 10, 2005.
(60) Provisional application No. 60/579,071, filed on Jun. 12, 2004.
(60) Provisional application No. 60/579,725, filed on Jun. 14, 2004.
(60) Provisional application No. 60/585,123, filed on Jul. 2, 2004.
(60) Provisional application No. 60/586,129, filed on Jul. 7, 2004.
(60) Provisional application No. 60/640,901, filed on Jan. 1, 2005.
(60) Provisional application No. 60/593,396, filed on Jan. 11, 2005.

(30) Foreign Application Priority Data
May 10, 2004 (CN) 200410022482.7
Jun. 1, 2004 (CN) 200410022672.9

(51) Int. Cl. G06F 13/12

(52) U.S. Cl. 710/74

(57) ABSTRACT

The present invention discloses a wireless multimedia device (wMD). It comprises a wireless communication means for directly and seamlessly communicating with a wireless hard-disk drive. Preferably, this wireless means has a short range and fast speed. With seamless communication, the wMD local storage can have a small capacity and/or use a volatile memory, thus significantly lowering the wMD cost.

### CROSS-REFERENCE TO RELATED APPLICATIONS

This application is a divisional of U.S. patent application Ser. No. 11/162,596, Filed Sep. 15, 2005, which is a continuation-in-part of U.S. patent application Ser. No. 10/908,383, Filed May 10, 2005, which is related to the following domestic applications:

1. Provisional Application Ser. No. 60/579,071, “Smart Hard-Disk Drive and Methods”, Filed Jun. 12, 2004;

2. Provisional Application Ser. No. 60/579,725, “Smart Hard-Disk Drive and Methods”, Filed Jun. 14, 2004;

3. Provisional Application Ser. No. 60/585,123, “Smart Hard-Disk Drive and Methods”, Filed Jul. 2, 2004;

4. Provisional Application Ser. No. 60/586,129, “Smart Hard-Disk Drive and Methods”, Filed Jul. 7, 2004;

5. Provisional Application Ser. No. 60/640,901, “HDD-Wireless Phone”, Filed Jan. 1, 2005;

6. Provisional Application Ser. No. 60/593,396, “Hard-Disk-Drive-Based Dual-Range Wireless Phone”, Filed Jan. 11, 2005;

and the following foreign applications:

1. China, P. R., application Ser. No. 200410022482.7, “Wireless Smart Hard-Disk Drive”, Filed May 10, 2004;

2. China, P. R., application Ser. No. 200410022672.9, “Smart Hard-Disk Drive and Methods”, Filed Jun. 1, 2004.

### BACKGROUND

1. Technical Field of the Invention

The present invention relates to the field of electronic storage systems, more particularly to portable wireless smart hard-disk drive (pwsHDD).

2. Prior Arts

Multimedia devices (MD) are devices that record and/or play multimedia (e.g. audio/video, i.e. A/V) data. They can be categorized into recording device (RD), playing device (PD) and multi-function device. The RD comprises at least a recording function, which converts external analog signals into multimedia data before recording them onto a storage medium. Examples include digital still camera, digital camcorder, and digital voice recorder. The PD comprises at least a playing function, which converts multimedia data into perceptible analog signals. Examples include audio player (e.g. MP3-player, CD player), video player (or movie player, e.g. portable VCD/DVD player, microdisplay-based player), game machine (e.g. Xbox, GameBoy, Nintendo DS), and global positioning system (GPS). Multi-function devices comprise both recording and playing functions. Examples include personal versatile recorder (PVR), camera (or video) phones with built-in MP3 player, and personal digital assistant (PDA). In the present invention, recording function and recording function are collectively referred to as multimedia functions.

Small form-factor hard-disk drive (HDD) has a disc-platter diameter of no larger than 2.5″. It is also known as portable HDD (pHDD). Recently, the pHDD storage capacity increases tremendously: for 2.5″ pHDD, it has reached 100 GB (equivalent to ˜250 hours of MPEG4 movies; ˜50,000 digital photos; or, ˜25,000 MP3 songs); for 1.8″ pHDD, it has reached 60 GB (equivalent to ˜150 hours of MPEG4 movies; ˜30,000 digital photos; or, ˜15,000 MP3 songs). If it is only used for a single multimedia application, the huge capacity of a pHDD will be wasted (e.g. pHDD in an HDD-based music-player). Only when shared by a large number of MD's, will the pHDD capacity be fully exploited.

U.S. patent applications Ser. Nos. 10/685,887, 10/902,646 disclose a smart hard-disk drive (sHDD) 8 (FIGS. 1A-1B). It comprises a host function (e.g. USB host, or USB OTG) which enables direct data transfer between the sHDD 8 and an MD 4 (e.g. digital still camera 4r of FIG. 1A, MP3 player 4p of FIG. 1B). Here, the word “direct” means no computer is needed as intermediary during data transfer. As a result, the sHDD 8 and its associated multimedia devices can be highly portable.

For the prior-art sHDD, whenever the local storage of an MD 4 is nearly full (or empty), data transfer needs to be performed. At this time, a user needs to connect the MD 4 with the sHDD 8 by a wire 8w. This wiring action needs user intervention and is inconvenient. Moreover, in order to reduce the number of wiring actions, the MD 4 needs a large local storage and this raises the MD cost. Accordingly, the present invention discloses a portable wireless smart hard-disk drive (pwsHDD). By directly and seamlessly communicating with at least one MD, it offers more user-convenience and lowers the system (more particularly, MD) cost.

### OBJECTS AND ADVANTAGES

It is a principle object of the present invention to provide a portable universal multimedia storage platform which can directly and seamlessly communicate with at least one multimedia device (MD)—a portable wireless smart hard-disk drive (pwsHDD).

It is another object of the present invention to provide a wireless multimedia device (wMD) that can directly and seamlessly communicate with a pwsHDD.

It is another object of the present invention to provide a pwsHDD-phone which would be a personal communication, computation and storage hub.

In accordance with these and other objects of the present invention, a portable wireless smart hard-disk drive (pwsHDD) and its associated wireless multimedia devices (wMD) are disclosed.

### SUMMARY OF THE INVENTION

To address the storage needs of multimedia devices (MD), the present invention discloses a portable wireless smart hard-disk drive (pwsHDD). It comprises a wireless communication means for directly and seamlessly transferring data with at least one wireless multimedia device (wMD). Here, the word “direct” means no computer intervention is needed during data transfer, i.e. the data-transfer process does not have to be controlled by a computer; the word “seamless” means no user intervention is needed during data transfer, i.e. a user does not need to take any action (e.g. connecting a wire, or clicking on a keypad) during data transfer. With a huge storage capacity, a single pwsHDD can store data for a number of MD's. It can replace various storage media (e.g. removable flash cards such as CF, MM, SD, MS, xD cards; videotapes such as VHS, 8 mm, Hi8, MiniDV, MicroMV; and optical discs such as CD, VCD, DVD) and become a universal multimedia storage platform.

To enable direct communication, either pwsHDD or wMD needs to comprise a host/master function or a host-like (e.g. peer-to-peer) function. There are three scenarios: A) when the wMD comprises a device/slave function, the pwsHDD needs to comprise a host/master function; B) when the pwsHDD comprises a device/slave function, the wMD needs to comprise a host/master function; or, C) both the wMD and pwsHDD comprise peer-to-peer functions.

To enable seamless communication, two conditions need to be met: A) wireless communication means is used; B) when the data stored inside the wMD local storage reach certain threshold, data transfer automatically starts between the pwsHDD and wMD. Condition A) eliminates wiring actions. It also enables simultaneous communication between a pwsHDD and multiple wMD's. This offers great flexibility and user-convenience. Condition B) eliminates the need for a user to manually start the data transfer by, e.g. clicking on a keypad. It can significantly lower the requirement on the capacity of the wMD local storage. To be more specific, the capacity of the wMD local storage can be smaller than the amount of data that the wMD records (or plays) during a user session. Here, a user session is the interval between two user actions (e.g. connecting a wire, or clicking on a keypad).

During normal usage, a user typically holds a wMD while the pwsHDD is placed in his pocket. The distance between the pwsHDD and wMD is small (e.g. ≦10 m, typically ≦3 m). Such a small distance means the wireless communication between them is a medium- to short-, preferably short-range wireless means. Compared with long-range wireless means (e.g. cellular phone), short-range wireless means is easier to design, have a faster speed, consumes less power and costs less.

Today, an MD records (or plays) data at a fast rate. For example, an MPEG4 player consumes data at ˜0.1 MB/s; a DVD player consumes data at ˜1 MB/s. Accordingly, the wireless communication means between the pwsHDD and wMD is a medium- to high-, preferably high-speed wireless means (e.g. ≧0.1 MB/s, typically ≧1 MB/s). For short-range wireless means, this speed value can be easily achieved. The wireless means that meet the above range and speed requirements include Bluetooth 2.0, Ultrawide Band (UWB), wireless USB, wireless 1394 and others.

Besides wireless means, a pwsHDD may further comprise wired communication means, e.g. USB, IEEE 1394 and Ethernet. This is particularly useful for large-volume data transfer. Besides storage function, a pwsHDD may further comprise at least one multimedia function. For example, a pwsHDD can have a built-in MP3 player, or a built-in digital camera. Moreover, a pwsHDD can also be a portion of a cellular phone. A pwsHDD-based cellular phone (pwsHDD-phone) would be a personal communication, computation and storage hub. It comprises at least two wireless communication means: a short-range wireless means (for high-speed, large-volume communication with wMD) and a long-range wireless means (for regular cellular communication). These two wireless means can share many system resources, e.g. microprocessor, memory, battery and display, thus lowering the overall system cost.

### BRIEF DESCRIPTION OF THE DRAWINGS

FIGS. 1A-1B illustrate a wired smart hard-disk drive (sHDD) and its usage models (prior arts);

FIG. 2 illustrates a preferred portable wireless smart hard-disk drive (pwsHDD) and its usage model;

FIG. 3 illustrates the usage of a pwsHDD as a universal multimedia storage platform, i.e. as a storage platform for a plurality of wireless multimedia devices (wMD);

FIGS. 4A-4B are two cross-sectional views of a preferred pwsHDD; FIG. 4C is a circuit block diagram of a preferred pwsHDD; FIG. 4D is a printed-circuit board (PCB) layout of a preferred pwsHDD;

FIGS. 5A-5B illustrates two preferred wireless recording devices (wRD); FIG. 5C is a circuit block diagram of a preferred wRD; FIG. 5D illustrates a preferred data-transfer process between a wRD and a pwsHDD;

FIG. 6A illustrates a first preferred wireless playing devices (wPD); FIGS. 6BA-6BB illustrate a second preferred wPD; FIG. 6C is a circuit block diagram of a preferred wPD; FIG. 6D illustrates a preferred data-transfer process between a wPD and a pwsHDD;

FIGS. 7AA-7CB illustrates several preferred wireless data interfaces of the pwsHDD and its associated wMD;

FIGS. 8A-8C illustrate several usage models of a preferred portable hybrid smart hard-disk drive (phsHDD); FIG. 8D is a circuit-block diagram of a preferred phsHDD;

FIG. 9 is a circuit-block diagram of a preferred pwsHDD with at least one multimedia function;

FIGS. 10A-10C are several perspective views of a preferred pwsHDD-phone;

FIGS. 11A-11C illustrate several usage models of a preferred pwsHDD-phone;

FIGS. 12A-12B are circuit-block diagrams of a preferred pwsHDD-phone and its data interface;

FIG. 13 illustrates a preferred driver-management method in a pwsHDD;

FIGS. 14A-14C illustrate the form factor, usage model and circuit blocks of a preferred interface-conversion apparatus.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The present invention discloses a portable wireless smart hard-disk drive (pwsHDD). It comprises a wireless communication means for directly and seamlessly transferring data with at least one wireless multimedia device (wMD). Here, the word “direct” means no computer intervention is needed during data transfer, i.e. the data-transfer process does not have to be controlled by a computer; the word “seamless” means no user intervention is needed during data transfer, i.e. a user does not need to take any action (e.g. connecting a wire, or clicking on a keypad) during data transfer.

Referring now to FIG. 2, a preferred pwsHDD 88 can directly download the captured data from a wireless recording device (wRD) 84r (e.g. a wireless digital still camera) through a wireless means 88wl. It may also directly upload the needed data to a wireless playing device (wPD) 84p (e.g. a wireless MP3 player) through a wireless means 88wl. Using wireless means eliminates wiring actions. Moreover, because it is wireless, the pwsHDD 88 can simultaneously communicate with at least two wMD's 84r, 84p. In sum, “wireless” offers great flexibility and user-convenience.

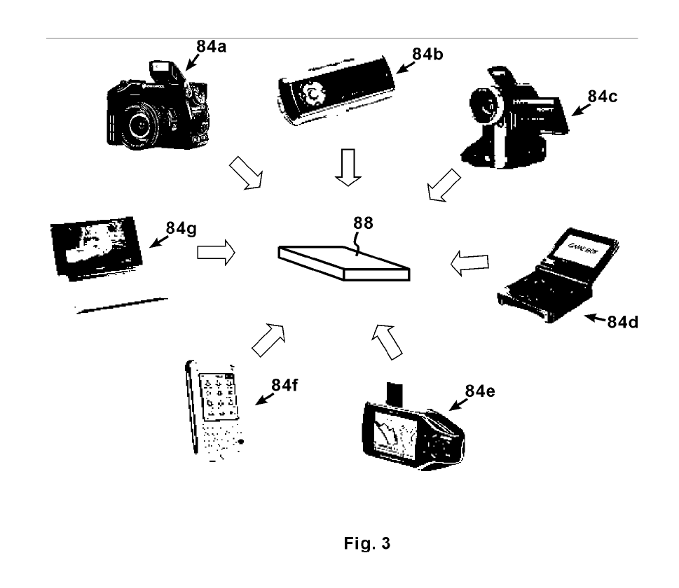

Currently, a digital photo needs ˜2 MB, an MP3 song needs ˜4 MB, and one hour of MPEG4 video needs ˜400 MB of storage. A typical “on-the-go” person needs ˜10-100 GB of storage space. This storage requirement can be easily satisfied by a portable HDD (pHDD): the storage capacity of a 2.5″ pHDD is now 100 GB, and 1.8″ pHDD is now 60 GB (and will soon reach 100 GB). Accordingly, a pwsHDD can be used as a universal multimedia storage platform. As is illustrated in FIG. 3, the pwsHDD can be used as a storage platform for a plurality of MD's, e.g. digital camera 84a, MP3 player 84b, digital camcorder 84c, game machine 84d, global position system (GPS) 84e, personal digital assistant (PDA) 84f, digital video player (e.g. DVD/VCD player) 84g. It can replace various storage media (e.g. removable flash cards such as CF, MM, SD, MS, xD cards; videotapes such as VHS, 8 mm, Hi8, MiniDV, MicroMV; and optical discs such as CD, VCD, DVD).

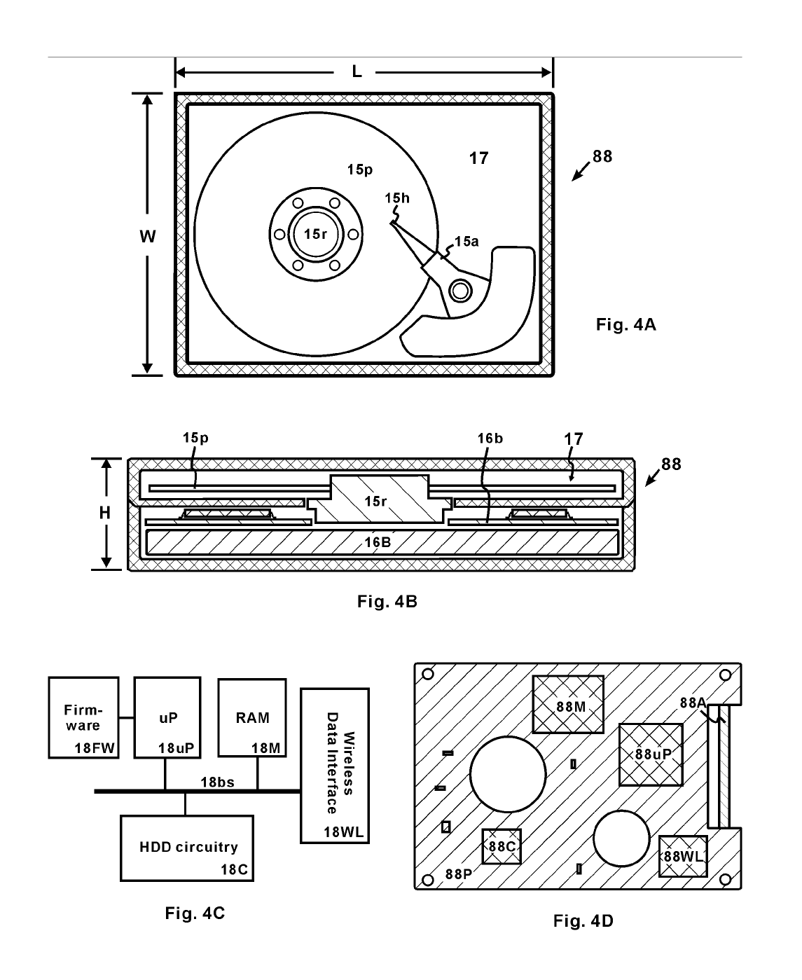

FIGS. 4A-4B are two cross-sectional views of a preferred pwsHDD 88. FIG. 4A is a cross-sectional view from the top (with top panel lifted). It can be observed that the pwsHDD comprises a head-disk assembly (HDA) 17, which includes at least one disc-platter 15p, rotor 15r, head 15h and arm 15a. FIG. 4B is its cross-sectional view from the front (with front panel removed). It can be observed that the pwsHDD comprises HDA 17, printed-circuit board (PCB) 16b, and battery 16B. To be portable, a pwsHDD 88 preferably satisfies at least one of the following conditions:

A) its disc-platter diameter is no larger than 2.5′;

B) its largest dimension is no larger than 20 cm;

C) its volume is no larger than 2000 cm³;

D) its weight is no more than 1000 g.

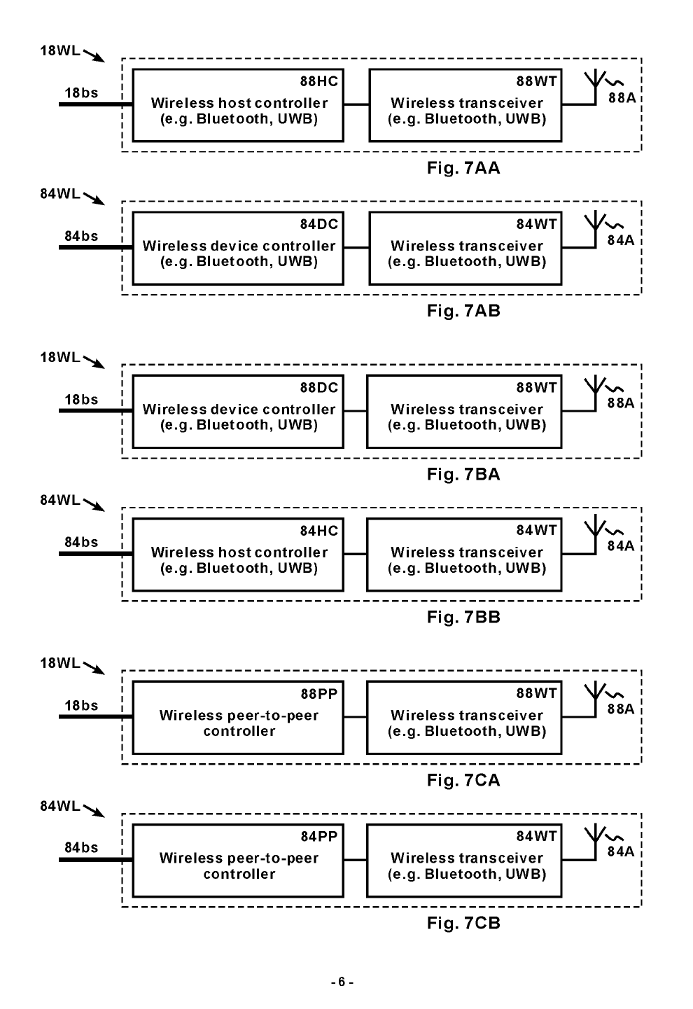

FIG. 4C is a circuit block diagram of a preferred pwsHDD 88. It comprises a microprocessor (uP) 18uP, firmware 18FW, RAM 18M, HDD circuitry 18C and wireless data interface 18WL. These circuit blocks communicate via the system bus 18bs. The uP 18uP and firmware 18FW are the “heart” of the pwsHDD 88. They enable direct and seamless communication between the pwsHDD 88 and wMD 84. The RAM 18M acts as a buffer for the pwsHDD 88. Its capacity is preferably large enough to enable “intermittent access” mode, which will be explained in the next paragraph. The HDD circuitry 18C include HDD controller, servo circuit and read channel. The wireless data interface 18WL provides communication channel between the pwsHDD and wMD. Its details are disclosed in FIGS. 7AA-7CB.

The “intermittent access” mode can be applied to both read and write. During read, a large amount of data are read out once from the HDA 17 and stored in the buffer 18M first. While these data are read out piecewise at a later time, the HDA 17 stays at standby. During write, data are written to the buffer 18M first. Only when the buffer 18M is almost full, the HDA 17 is turned on and all data in the buffer 18M are written to the HDA 17 once. The “intermittent access” mode can shorten the running time of the HDA 17 and lower its power consumption, provided the following condition is satisfied:
S_{M}>E_{HDA}/{P_{HDA}*(1/R_{MD}−1/R_{HDA})},
where, S_{M} is the capacity of the buffer 18M; E_{HDA} is the energy consumption to start the HDA 17; P_{HDA} is the power consumption during active read or write of the HDA 17; R_{MD} is the rate at which an MD 84 records or plays multimedia data; and R_{HDA} is the rate at which the HDA 17 reads or writes data.

FIG. 4D is a PCB layout of a preferred pwsHDD 88. In order to lower the overall system cost, an “HDD integration” method is used. Details of this method are disclosed in U.S. patent application Ser. No. 10/902,646, “Smart Hard-Disk Drive”, filed Jul. 28, 2004 by the same inventor. According to this method, at least a portion of the HDD chips 88C (e.g. HDD controller, servo, and read channel) is integrated on the same PCB 88P with at least a portion of the system chips (e.g. uP chip 88uP, memory chip 88M and wireless data interface chip 88WL). This method can lower the overall system cost and improve the data-transfer speed.

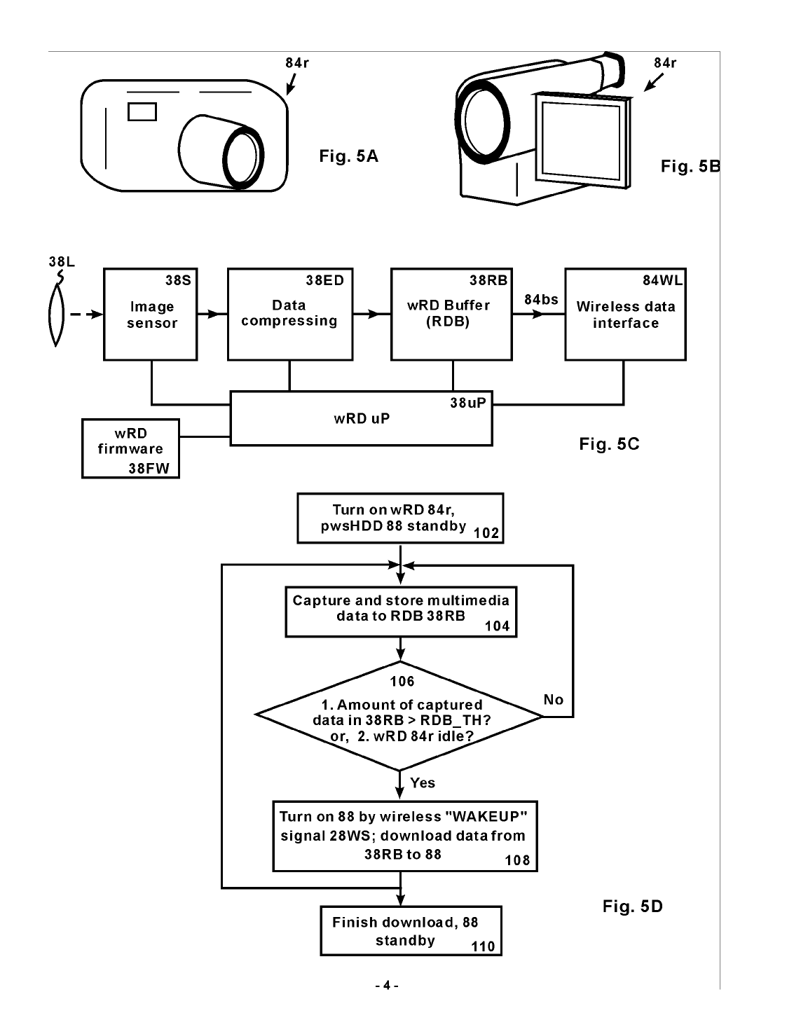

FIGS. 5A-5B illustrate two preferred wireless recording devices (wRD) 84r. They are preferably portable. FIG. 5A is a wireless digital camera 84r and FIG. 5B is a wireless digital camcorder 84r. They can both download the captured data to a pwsHDD 88 through a wireless means 88wl. From FIG. 5C, a wRD 84r preferably comprises a wRD uP 38uP, firmware 38FW, lens 38L, image sensor 38S, data compressing block 38ED, wRD buffer (RDB) 38RB and wireless data interface 84WL. The wRD uP 38uP and firmware 38FW are the “heart” of the wRD 84r. They enable direct and seamless communication between the pwsHDD 88 and wRD 84r. The lens 38L, image sensor 38S and data compressing block 38ED capture and converts images into multimedia data. The RDB 38RB uses the local storage of the wRD 84r and temporarily stores these multimedia data. The wireless data interface 84WL provides data communication channel between the pwsHDD 88 and wRD 84r. Its details are disclosed in FIGS. 7AA-7CB. Apparently, this circuit block diagram can also be applied to other wRD, e.g. digital voice recorder.

FIG. 5D illustrates a preferred data-transfer process between a pwsHDD 88 and a wRD 84r. It comprises the following A)-E) steps: STEP A) Turn on the wRD 84r; the pwsHDD 88 stands by (step 102); STEP B) The wRD 84r captures multimedia data and store them in the RDB 38RB (step 104); STEP C) If 1) the amount of data in the RDB 38RB exceeds a pre-determined threshold RDB_TH, or, 2) the wRD 84r is idle, then the wRD 84r sends out a wireless “WAKEUP” signal 28WS (step 106); STEP D) Signal 28WS activates the pwsHDD 88; data in the RDB 38RB are downloaded into the pwsHDD 88 (step 108); STEP E) Once data are downloaded, the pwsHDD 88 go back to standby (step 110).

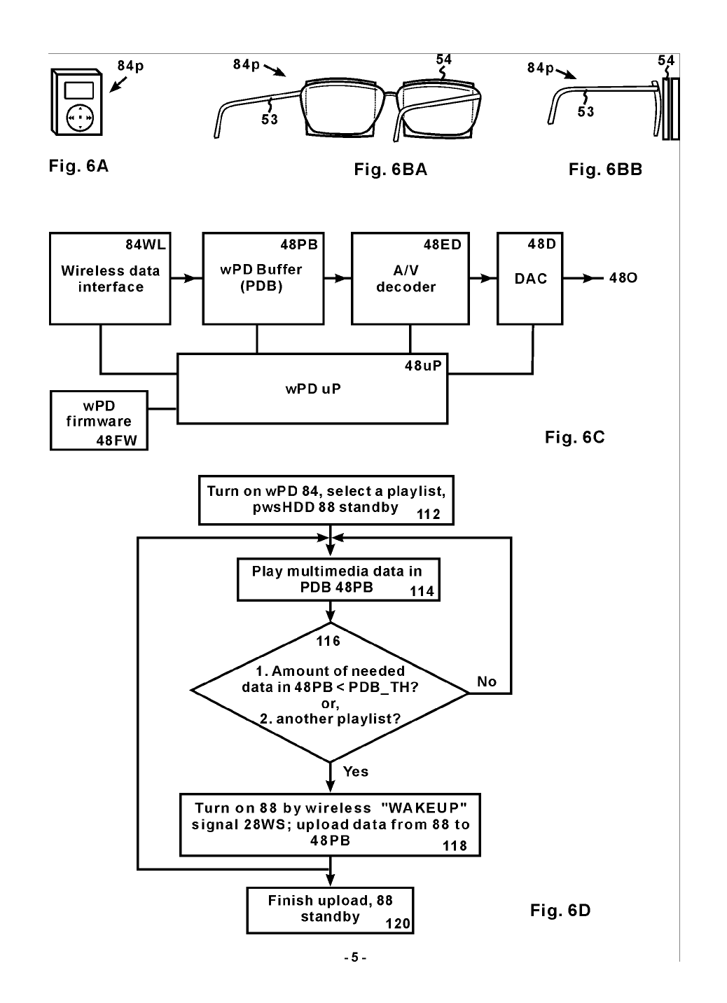

FIGS. 6A-6BB illustrate two preferred wireless playing devices (wPD) 84p. They are preferably portable. FIG. 6A is a preferred wireless MP3 player 84p and it can upload the needed data from a pwsHDD 88 through a wireless means. FIGS. 6BA-6BB are the perspective and side views of a preferred microdisplay-based wPD. It comprises a microdisplay chip 54 and an eyeglass structure 53. Microdisplay is a mature technology (referring to Wright et al. “Die-sized displays enable new applications”, Semiconductor International, September 1998). Being much lighter and smaller, microdisplay can form images as good as from conventional displays. The microdisplay-based player (wireless or wired) will make a revolutionary change to the video-watching experience, as much as the MP3 player did to the music-listening experience.

From FIG. 6C, a wPD 84p preferably comprises a wPD uP 48uP, firmware 48FW, wireless data interface 84WL, wPD buffer (PDB) 48PB, A/V decoder 48ED, and D/A converter 48D. The wRD uP 48uP and firmware 48FW are the “heart” of the wPD 84p. They enable direct and seamless communication between the pwsHDD 88 and wPD 84p. The wireless data interface 84WL provides communication channel between the pwsHDD 88 and wPD 84p. Its details are disclosed in FIGS. 7AA-7CB. The PDB 48PB uses the local storage of the wPD 84p and temporarily stores multimedia data uploaded from the pwsHDD 88. The A/V decoder 48ED and D/A converter 48D decode and convert these multimedia data into analog outputs 48O. Apparently, this circuit block diagram can be applied to other wPD, e.g. audio player, video player, game machine, and GPS.

FIG. 6D illustrates a preferred data-transfer process between a pwsHDD 88 and a wPD 84p. It comprises the following A)-E) steps: STEP A) Turn on the wDP 84p and select a playlist; the pwsHDD 88 stands by (step 112); STEP B) The wDP 84p plays multimedia data in the PDB 48PB (step 114); STEP C) If 1) the amount of needed data in the PDB 48PB falls below a pre-determined threshold PDB_TH, or, 2) another playlist is selected, then the wPD 84p sends out a wireless “WAKEUP” signal 28WS (step 116); STEP D) Signal 28WS activates the pwsHDD 88; data are uploaded from the pwsHDD 88 (step 118); STEP E) Once data are uploaded, the pwsHDD 88 go back to standby (step 120).

In the pwsHDD 88 and wMD 84, firmwares 18FW (FIG. 4C), 38FW (FIG. 5C) and 48FW (FIG. 6C) are designed in such a way that, when the amount of data in the wMD buffer (38RB, 48PB) reaches a pre-determined threshold (RDB_TH, PDB_TH), data transfer will automatically start (FIGS. 5D, 6D). As a result, a user does not need to manually start the data transfer by, e.g. clicking on a keypad. Combined with wireless means, this design approach will realize seamless data transfer.

One important consequence of the seamless data transfer is that the wMD local storage (38RB, 48PB) can have a small capacity. To be more specific, it can be smaller than the amount of data that the wMD 84 records (or plays) during a user session. Here, a user session is the interval between two user actions (e.g. connecting a wire, or clicking on a keypad). Moreover, because it is used as a buffer (38RB, 48PB) for temporary data storage, the wMD local storage may use volatile memory (e.g. DRAM), not the more expensive non-volatile memory. In sum, the wMD local storage can have a small capacity and/or use a volatile memory. This can significantly lower the wMD cost.

To enable direct communication, either a pwsHDD or its associated wMD needs to comprise a host/master function or a host-like (e.g. peer-to-peer) function. There are three scenarios and they are illustrated in FIGS. 7AA-7CB. In scenario A) (FIGS. 7AA-7AB), the pwsHDD 88 acts as host and comprises an antenna 88A, a wireless transceiver 88WT and a wireless host controller 88HC (FIG. 7AA); the wMD 84 acts as device/slave and comprises an antenna 84A, a wireless transceiver 84WT, and a wireless device controller 84DC (FIG. 7AB). In this preferred embodiment, the pwsHDD 88 issues data-transfer commands. In scenario B) (FIGS. 7BA-7BB), the pwsHDD 88 acts as device/slave and comprises a wireless device controller 88DC, among others (FIG. 7BA); the wMD 84 acts as host and comprises a wireless host controller 84HC, among others (FIG. 7BB). In this preferred embodiment, the wMD 84 issues data-transfer commands. In scenario C) (FIGS. 7CA-7CB), peer-to-peer wireless communication is used. Both the pwsHDD 88 and the wMD 84 have a wireless peer-to-peer controller 88PP, 84PP. Consequently, both can issue data-transfer commands. As a universal multimedia storage platform, the pwsHDD 88 preferably supports at least some host function.

During normal usage, a user typically holds a wMD while the pwsHDD is placed in his pocket. The distance between the pwsHDD and wMD is small (e.g. ≦10 m, typically ≦3 m). Such a small distance means the wireless communication between them is a medium- to short-, preferably short-range wireless means. Compared with long-range wireless means (e.g. cellular phone), short-range wireless means is easier to design, have a faster speed, consumes less power and costs less.

Today, an MD records (or plays) data at a fast rate. For example, an MPEG4 player consumes data at ˜0.1 MB/s; a DVD player consumes data at ˜1 MB/s. Accordingly, the wireless communication means between the pwsHDD and wMD is a medium- to high-, preferably high-speed wireless means (e.g. ≧0.1 MB/s, typically ≧1 MB/s). For short-range wireless means, this speed value can be easily achieved.

The wireless means that meet the above range and speed requirements include Bluetooth 2.0, Ultrawide Band (UWB), wireless USB, wireless 1394 and others. Bluetooth 2.0 is a short-range, low-power and low-cost wireless technology. Its transfer speed is 3.8˜11.4 Mb/s, suitable for pwsHDD. Wireless USB (or 1394) is a short-range, low-power, low-cost and high-speed (up to ˜480 Mb/s) wireless technology. UWB is proposed as its PHY layer. Besides these, a pwsHDD may also use wireless technologies defined in, e.g. IEEE 802.11, IEEE 802.15, and IEEE 802.16.

When a large amount of data (˜GB) needs to be transferred, wired communication has certain advantages. Accordingly, the present invention discloses a portable hybrid smart hard-disk drive (phsHDD). It comprises both wireless and wired communication means. The usage model of the wireless means is similar to FIG. 2. The usage models of the wired means include: phsHDD-device, phsHDD-storage and phsHDD-computer.

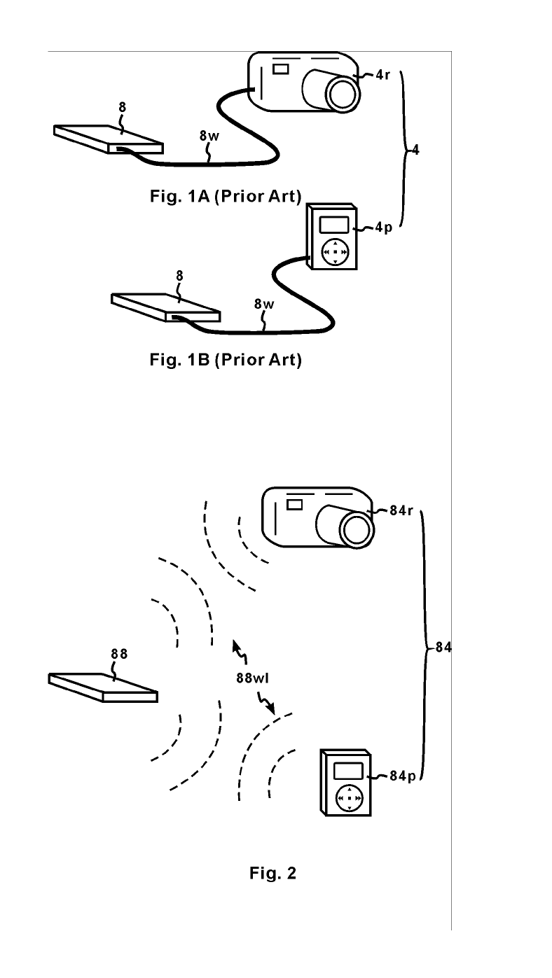

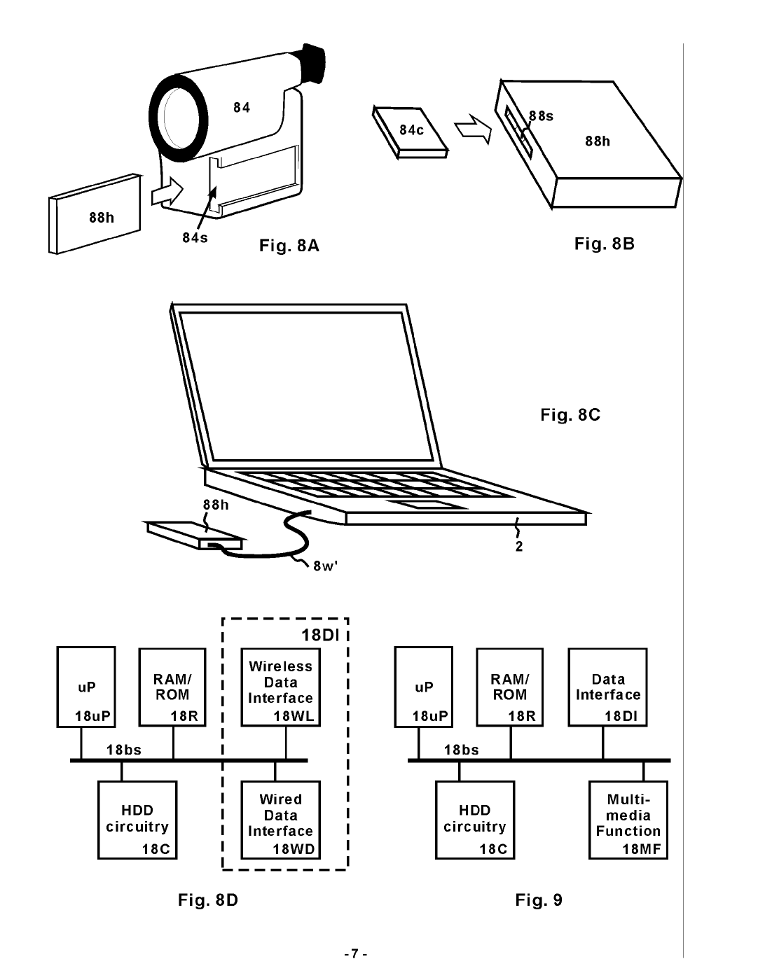

The phsHDD-device model refers to wired data transfer between a phsHDD 88h and an MD 84. One example is illustrated in FIGS. 1A-1B. By connecting a phsHDD 88h with an MD 84 by a wire 8w, direct data transfer is realized. Examples of communication protocols include USB, IEEE 1394 and Ethernet. Another example is illustrated in FIG. 8A. Here, the body of an MD 84 (e.g. a digital camcorder) is large enough to hold a phsHDD 88h (through a slot 84s). In this configuration, data are constantly transferred between the phsHDD 88h and MD 84. As a result, the MD 84 may use a small and/or volatile local storage, thus lowering its cost.

The phsHDD-storage model refers to wired data transfer between a phsHDD 88h and a removable storage 84c, which is used by an MD 84. As is illustrated in FIG. 8B, the phsHDD 88h has a built-in card slot 88s. The removable storage (e.g. a CF card) 88c can be inserted into said card slot 88s and directly communicate with the phsHDD 88h. Here, the removable storage could be any type of removable flash cards, such as CF, MM, SD, MS, and xD cards.

The phsHDD-computer model refers to wired data transfer between a phsHDD 88h and a computer 2. As is illustrated in FIG. 8C, a wire 8w′ connects the phsHDD 88h with the computer 2. The computer 2 has more processing power for multimedia data, faster access to multimedia content (e.g. optical-discs and internet); it also has better input/output (e.g. a large keyboard and display). In general, a phsHDD 88h (or sHDD 8, pwsHDD 88) needs to download multimedia content from a computer 2, or upload the recorded data to a computer 2. Because the volume of data transfer could be large, wired means is preferred, although wireless means is also feasible.

FIG. 8D is a circuit block diagram of a preferred phsHDD. Compared with FIG. 4C, its data interface block 18DI further comprises a wired data interface 18WD. Examples of wired data interface include various wired controllers (e.g. USB controller, 1394 controller), various storage-card controllers (e.g. CF-card controller, MM-card controller) and others.

Besides storage function, a pwsHDD may further comprise at least one multimedia function 18MF (FIG. 9). It could be a recording function, a playing function, or both. For example, a pwsHDD could comprise a built-in MP3 player, which directly plays the audio files stored in the pwsHDD; it could also comprise a built-in digital camera, which saves photos directly onto the pwsHDD.

A pwsHDD can also be a portion of a cellular phone. A pwsHDD-based cellular phone (pwsHDD-phone) would be a personal communication, computation and storage hub. It comprises at least two wireless communication means: a short-range wireless means (for high-speed, large-volume communication with wMD) and a long-range wireless means (for regular cellular communication). Short-range wireless means is faster and consumes less power than the long-range means, thus it is more suitable for data transfer between the pwsHDD-phone and wMD.

FIGS. 10A-10C illustrate several perspective views of a preferred pwsHDD-phone 110. FIG. 10A is its front view. It comprises a display 112, input 114, and antenna 116. FIG. 10B is its back view. It further comprises an HDD 118 and a battery 120. The HDD 118 can be either detached from the phone 110 or integrated into the phone 110. FIG. 10C is a side view of the HDD 118 from the tail end of the phone. The HDD 118 comprises an interface 118i. This interface 118i could be used to provide a wired communication channel with an MD or a computer.

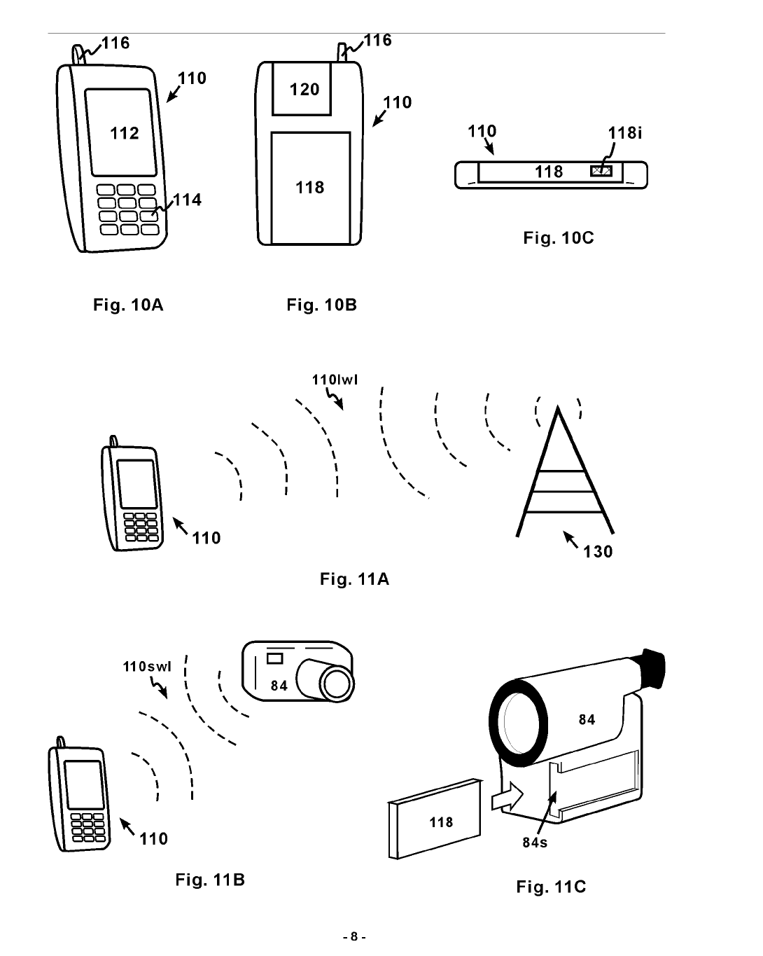

FIGS. 11A-11C illustrate three usage models of a preferred pwsHDD-phone 110. FIG. 11A illustrates a long-range wireless communication model. The pwsHDD-phone 110 communicates with a base station 130 in the cellular network through a long-range wireless communication means 110lwl. FIG. 11B illustrates a short-range wireless communication model. The pwsHDD-phone 110 directly and seamlessly communicates with a wMD 84 through a short-range wireless communication means 110swl. FIG. 11C illustrates a wired communication model. After inserting the HDD 118 (or the pwsHDD-phone 110) into a slot 84s on the MD 84 (e.g. a digital camcorder), constant communication is established between the pwsHDD-phone 110 and MD 84.

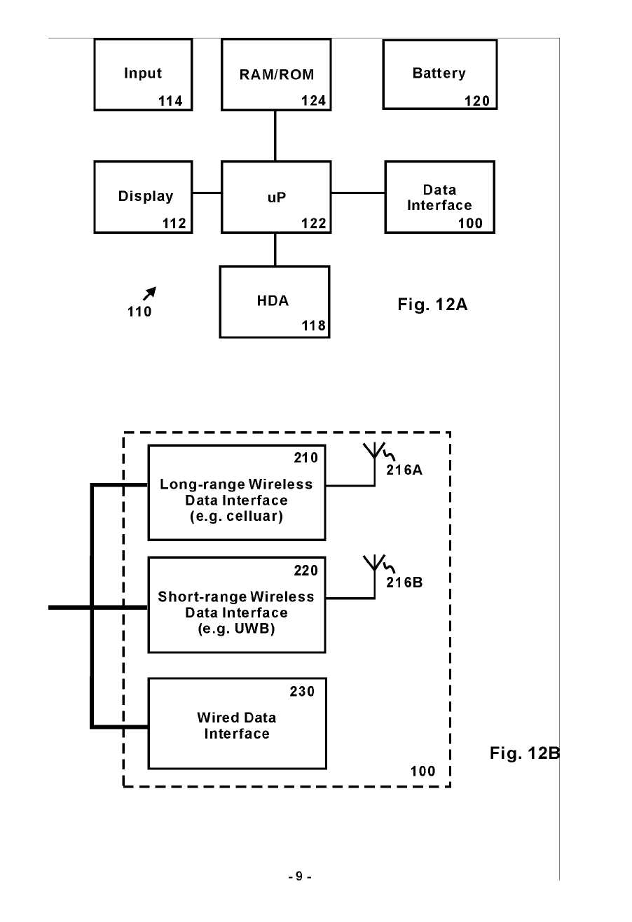

FIG. 12A is a circuit block diagram of a preferred pwsHDD-phone 110. It comprises a uP 122, system memory (RAM/ROM) 124, battery 120, display 112, input 114, HDD 118 and data interface 100. One advantage of the pwsHDD-phone is that short- and long-range communication means can share many system resources, e.g. uP, system memory, battery, display and input, thus lowering the overall system cost. FIG. 12B is a detailed circuit block diagram of the data interface 100. It comprises a long-range wireless interface 210, a short-range wireless interface 220, and a wired data interface 230. The long-range wireless interface 210 provides regular cellular function through antenna 216A. The short-range wireless interface 220 provides high-speed data-transfer capabilities between the phone 110 and wMD 84 through antenna 216B. The wired data interface 230 provides wired data-transfer capabilities between the phone 110 and MD 84 (or computer). It is suitable for large-volume data transfer.

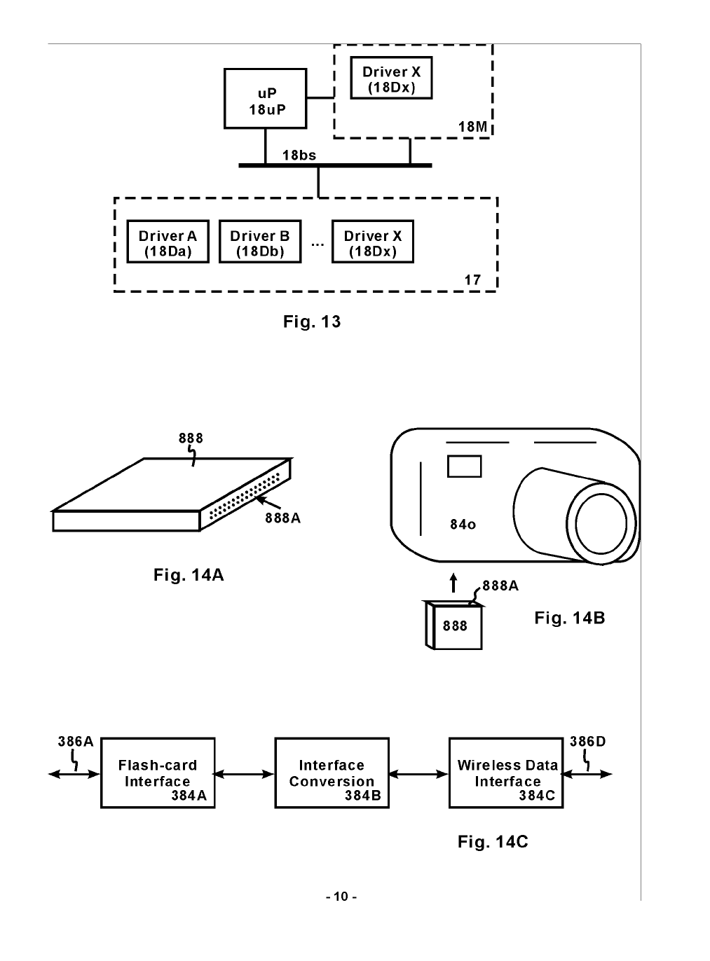

Referring now to FIG. 13, a preferred driver-management method is disclosed. As a universal multimedia storage platform, a pwsHDD 88 needs to support a large number of MD's. Their drivers (18Da, 18Db . . . ) may require a large storage space. In prior art, these drivers are burnt into the system ROM, which could be expensive and inflexible. Using this driver-management method, all drivers (18Da, 18Db . . . 18Dx) are stored in the HDA 17. When an MD 84 is connected to the pwsHDD 88, it is first enumerated and then the appropriate driver 18Dx is uploaded to the system memory 18M. Accordingly, there is one driver 18Dx in the system memory 18M. Apparently, this method is more flexible and can lower the system cost.

Referring now to FIGS. 14A-14C, a preferred interface-conversion apparatus 888 is illustrated. This interface-conversion apparatus 888 can convert a wired communication into a wireless communication. Using this apparatus 888, a legacy MD 84o (e.g. a legacy digital camera), which does not have wireless capabilities, can directly and seamlessly communicate with a pwsHDD 88. In this preferred embodiment, the interface-conversion apparatus 888 is CF-card-like. To be more specific, it has the same form factor and interface 888A as a conventional CF card (FIG. 14A). After being inserted into the CF-card slot of a legacy MD 840 (FIG. 14B), it can convert data from the CF-format 386A, which is the legacy format between the MD 840 and its CF card, to a wireless format 386D, which enables seamless communication. From FIG. 14C, this apparatus 888 comprises a CF-card interface 384A, an interface-conversion block 384B, and a wireless interface 384C. Besides CF card, it can also provide interface conversion for other removable storage (e.g. MM, SD, MS, xD cards . . . ), or videotapes (e.g. VHS, 8 mm, Hi8, MiniDV, MicroMV . . . ).

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

What is claimed is:

1. A wireless multimedia device, comprising:
at least one multimedia function;
a local storage for temporarily storing data for said multimedia function; and
a wireless communication means for directly and seamlessly transferring data between said wireless multimedia device and a wireless hard-disk drive.

2. The wireless multimedia device according to claim 1, wherein said local storage can have a smaller capacity than the amount of data said multimedia device records or plays during a user session.

3. The wireless multimedia device according to claim 1, wherein data transfer automatically starts between said multimedia device and said wireless hard-disk drive, when the amount of data in said local storage reaches a pre-determined threshold.

4. The wireless multimedia device according to claim 1, wherein said local storage is a volatile memory.

5. The wireless multimedia device according to claim 1, further comprising a wireless function selected from wireless device/slave function, wireless host/master function and wireless peer-to-peer function.

6. The wireless multimedia device according to claim 1, wherein said wireless communication means is a medium- to short-range wireless means.

7. The wireless multimedia device according to claim 6, wherein said wireless means has a range of no longer than 10 m.

8. The wireless multimedia device according to claim 7, wherein said wireless means has a range of no longer than 3 m.

9. The wireless multimedia device according to claim 1, wherein said wireless communication means is a medium- to high-speed wireless means.

10. The wireless multimedia device according to claim 9, wherein said wireless means has a speed of no slower than 0.1 MB/s.

11. The wireless multimedia device according to claim 10, wherein said wireless means has a speed of no slower than 1 MB/s.

12. The wireless multimedia device according to claim 1, wherein said wireless communication means is selected from a group of wireless means consisting of Bluetooth, Ultrawide Band, wireless USB, wireless 1394, IEEE 802.11, IEEE 802.15, and IEEE 802.16.

13. The wireless multimedia device according to claim 1, further comprising a wired communication means for directly transferring data between said multimedia device and a hard-disk drive.

14. The wireless multimedia device according to claim 12, wherein said wired communication means is selected from a group of wired means consisting of USB, IEEE 1394, and Ethernet.

15. The wireless multimedia device according to claim 1, further being portable.

16. The wireless multimedia device according to claim 1, wherein said multimedia function comprises a recording function and/or a playing function.

17. The wireless multimedia device according to claim 1 being selected from a group of devices consisting of digital camera, digital camcorder, digital voice recorder, digital audio player, earphone, digital video player, microdisplay-based display, game machine, global positioning system (GPS), personal versatile recorder (PVR), cellular phone, and personal digital assistant (PDA).

18. An interface-conversion apparatus associated with a wired multimedia device having a removable storage, comprising: a communication-conversion means for converting the wired communication means between said multimedia device and said removable storage into a wireless communication means between said multimedia device and a wireless hard-disk drive, wherein the form factor and interface of said interface-conversion apparatus are similar to said removable storage.

19. The interface-conversion apparatus according to claim 18, wherein said wireless communication means is a medium- to short-range wireless means.

20. The interface-conversion apparatus according to claim 18, wherein said wireless communication means is a medium- to high-speed wireless means.
